(19) United States
(12) Patent Application Publication
(10) Pub. No.: US 2007/0013168 A1
(43) Pub. Date: Jan. 18, 2007

(54) Wheel steering mechanism for baby stroller

(75) Inventor: Wei-Yeh Li, Tainan County (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/482,787

(22) Filed: Jul. 10, 2006

(30) Foreign Application Priority Data
Jul. 12, 2005 (TW) 094211845

(51) Int. Cl. B62B 7/00

(52) U.S. Cl. 280/642

(57) ABSTRACT

A wheel steering mechanism for baby stroller is capable of selecting the controls of the engaging and releasing of the positioning pin and the wheel seat by making use of the downward pressing of the pressing key in single direction. When the pressing key is pressed down for the first time to make the positioning pin engage with the wheel seat, the wheel seat appears to be in the status of fixed-direction steering. When the pressing key is pressed down for the second time to make the positioning pin separate from the wheel seat, the wheel assembly is capable of restoring back to the status of free steering. Based on this kind of design, the invention is capable of providing the operator to directly step on the pressing key in order to control the status of either fixed-direction steering or non-fixed-direction steering of the wheel assembly. In this way, the invention is capable of providing the operator with the advantages that the operation is easy to handle and all he or she has to do is exerting force to press the pressing key to move it downward making the invention has the effect of not damaging the operator's shoe vamp.

### BACKGROUND OF THE INVENTION

1. Field of the Invention

The invention relates to a wheel steering mechanism for baby stroller, and more particularly, to a wheel steering mechanism for baby stroller that the operator can switch the status of fixed-direction steering or the non-fixed-direction steering by simply pressing the pressing key in single direction.

2. Description of the Prior Art

When it comes to push around a baby stroller, for the sake of labor-saving and smoothly pushing, a wheel assembly that is capable of steering in different direction is added at the front wheel tube or the rear wheel tube of the baby stroller (manually pushing rod is capable of changing the pushing direction). An more advanced design is to add a positioning structure to the wheel assembly to make the wheel assembly freely steer in any direction or fix in a single steering direction.

FIG. 1 is a schematic front view of the steering mechanism for baby stroller of the prior art. As shown in FIG. 1, the positioning structure of the wheel assembly of the prior art being generally installed at the foot tube (10) includes a wheel seat (1) for pivotally connecting to the wheel, a central axis of rotating shaft (11), a stepping rod (12), and a positioning member (13). Among them, the central axis of rotating shaft (11) having a positioning hole (14) is secured at the foot tube (10) while the wheel seat (1) is pivotally connected to and rotating with respect to the central axis of the rotating shaft (11). The positioning member (13) being installed within the wheel seat (1) is capable of moving up-and-down and engaging with the positioning hole (14) of the central axis of rotating shaft (11) to undertake positioning action by engaging each other. In this way, the wheel assembly is capable of achieving the objects of rotating in a single fixed direction or rotating freely in any direction. The positioning structure of the wheel assembly of the prior art is mainly controlled by the action of the stepping rod (12) that being positioned between the two wheels is pivotally connected to the wheel seat (1). Since the diameter of the general wheel is greater than that of the wheel seat (2), it is very inconvenient for the operator intending to control the rotating direction of the wheel assembly that not only does he/or she need to operate in front of the wheel assembly, he/or she has to stretch his/or her feet or hands between the two wheel as well in order to undertake the operation. Moreover, when it comes to pushing the stepping rod upward for releasing the status of positioning, for the most direct way, the operator needs to hook up the stepping rod by the use of his/or her feet. In this way, his/or her shoe vamp will be damaged, and this is the demerit of the prior art.

### SUMMARY OF THE INVENTION

In order to resolve the above-mentioned demits of the position of the positioning mechanism of the wheel assembly of the prior art and the inconvenience of the operation, as well as to protect the operator's shoe vamp from being damaged, the invention makes use of a pressing key, a steering control assembly, and a positioning pin to control the status of either fixed-direction steering or free steering of the wheel assembly. The steering control assembly makes use of the design that a multi-pair of slant surfaces accommodates the rotation. This kind of design makes the wheel assembly appear fixed-direction steering by the use of the steering control assembly to drive the positioning pin for engaging the wheel assembly when the pressing key installed above the wheel assembly is pressed to move down for the first time. But when the operator presses the pressing key for the second time, the positioning pin will separate from the wheel seat so as to make the wheel assembly appear to be a status of free steering. By the use of this kind of design, the operator can directly step on the pressing key to control the status of fixed-direction steering or non-fixed-direction steering. Therefore, the invention can achieve the effects of being convenient in operation and not damaging the operator's shoe vamp since the operator always makes the pressing key (4) move in downward direction.

The accomplishment of this and other objectives and the range of suitability of the application of the invention will become apparent from the following description and its accompanying drawings of which:

### BRIEF DESCRIPTION OF THE DRAWINGS

FIG. 1 is a schematic front view of the steering mechanism for baby stroller of the prior art;

FIG. 2 is a schematic and isometric view of the steering mechanism installed in the baby stroller of the invention;

FIG. 3 is a schematic and exploded view of the wheel seat and the steering control assembly of the invention;

FIG. 4 is a schematic and exploded view of the wheel seat members of the invention;

FIG. 5 is a schematic and exploded view of the steering control assembly members of the invention;

FIG. 6 is a cross-sectional view of the main body of the steering control assembly of the invention;

FIG. 7 is a plan view of the main body of the steering control assembly of the invention;

FIG. 8 is a schematic diagram of the operation of the steering control assembly having the positioning pin moving downward of the invention;

FIG. 9 is a schematic diagram of the operation of the steering control assembly having the positioning pin moving upward of the invention.

### DETAILED DESCRIPTION OF THE PREFERRED EMBODI-MENT

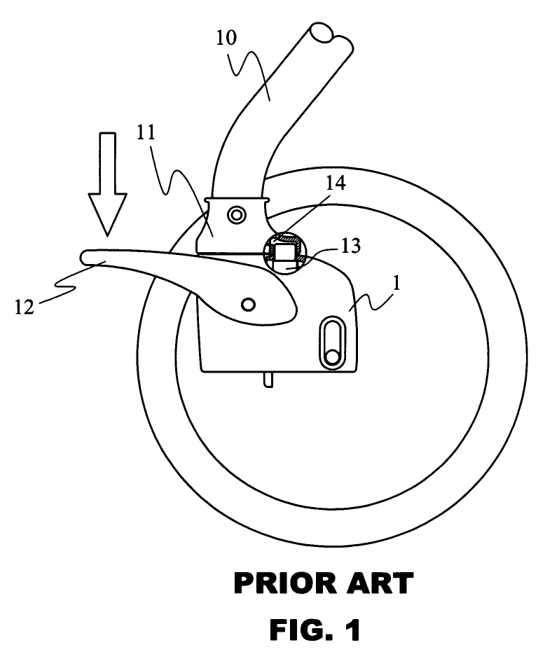

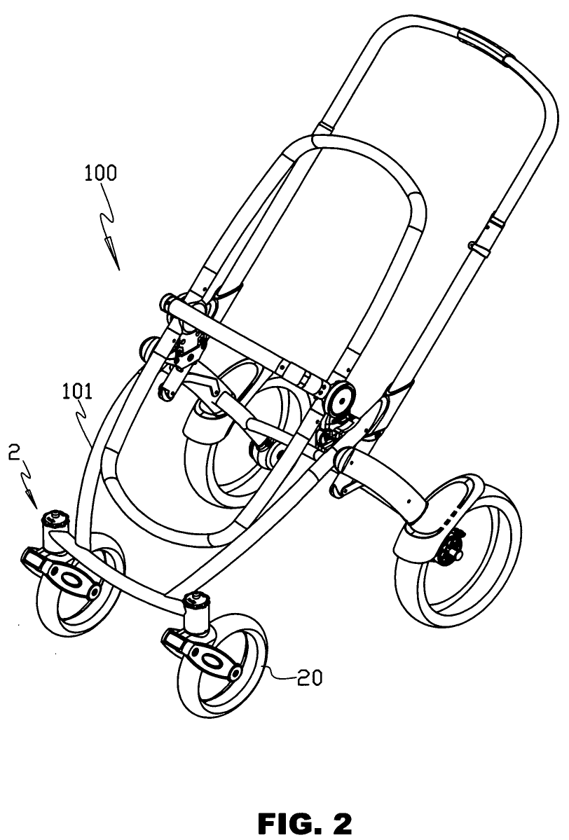

FIGS. 1, 2, and 3 shows the embodiment of the wheel steering mechanism for baby stroller of the invention. As shown in FIGS. 1, 2, and 3, the wheel steering mechanism for baby stroller of the invention being installed at the lower end of a foot tube (101) of the frame of the baby stroller is for switching to either the fixed direction set-up or the non-fixed direction set-up. The wheel steering mechanism of the invention includes a wheel seat (2), a steering control assembly (3), and a pressing key (4).

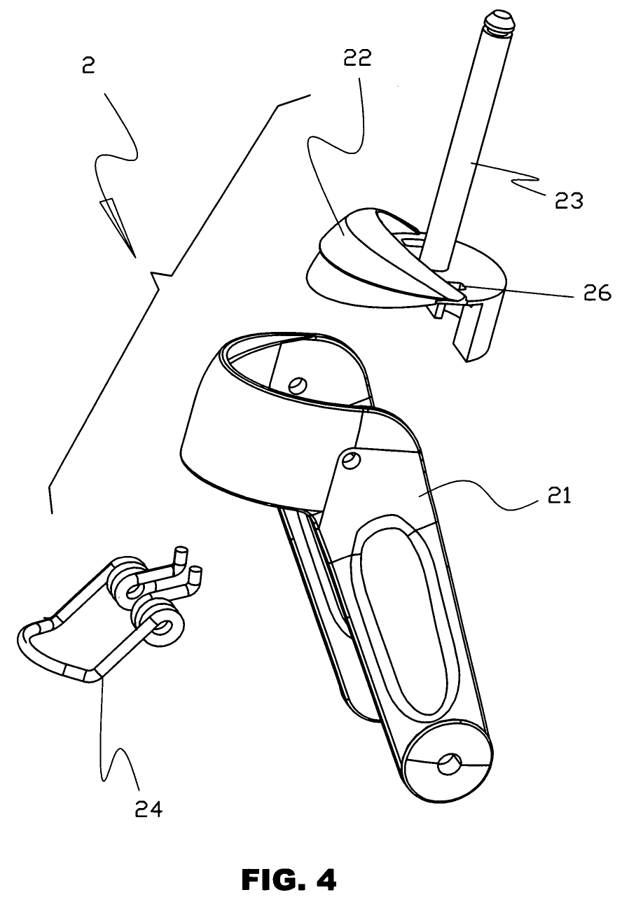

The wheel seat (2) is used for pivotally connecting to the wheel (20). In the present embodiment, the wheel seat (2) further includes a connecting seat (21), a pivotally connecting seat (22), a pivot shaft (23), and a shock-resistant spring (24) (see FIG. 4). The connecting seat (21) has two extended sheets (211) (not shown in the Figure) extended therefrom for pivotally connecting to the wheel (20). As shown in FIG. 4, the connecting seat (21) and the pivotally connecting seat (22) being pivotally connected each other have a shock-resistant spring (24) provided between them such that the connecting seat (21) is capable of performing rotation and having the shock-resistant function through the shock-resistant spring (24). The pivotally connecting seat (22) can also perpendicularly connect to a pivot shaft (23) for pivotally connecting to the steering control assembly (3). In the present embodiment, a positioning spot (26) such as a positioning hole (not shown in the Figure) can be provided on the top of the pivotally connecting seat (22).

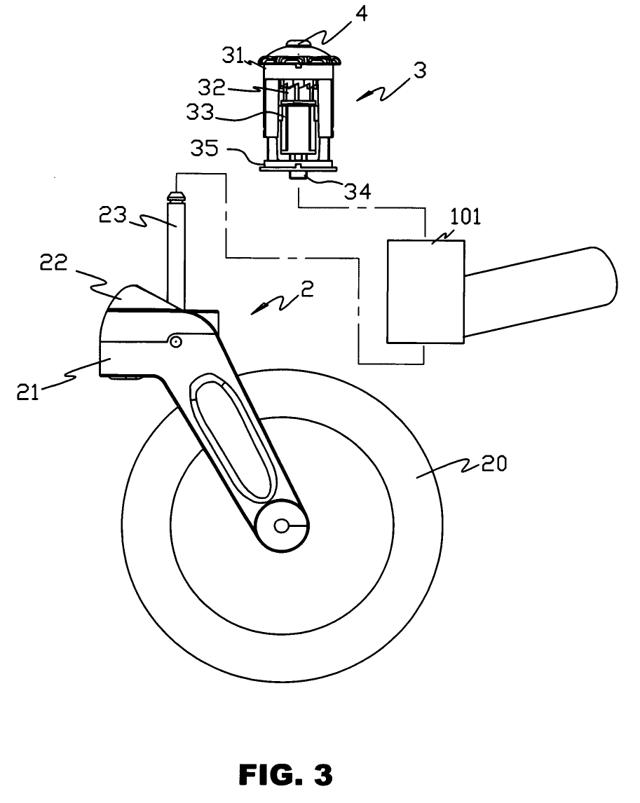

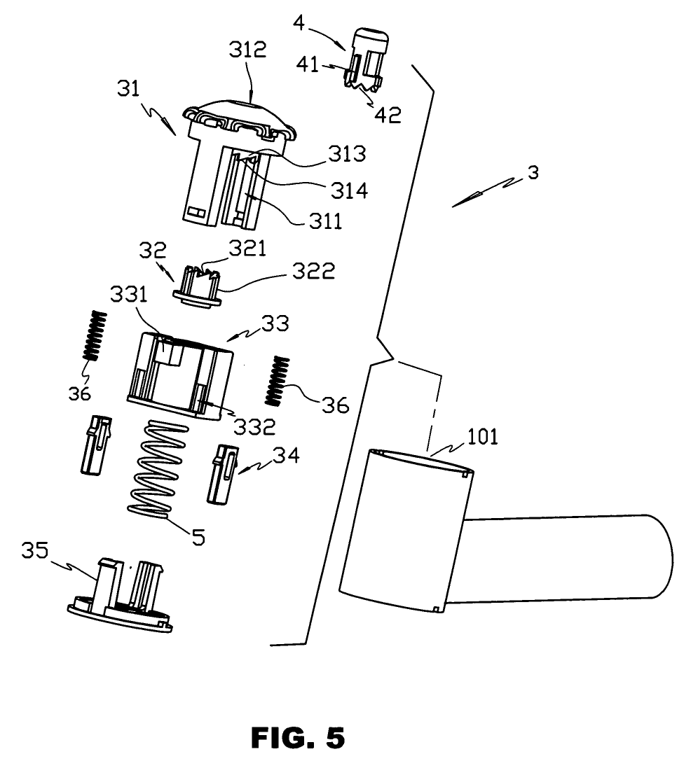

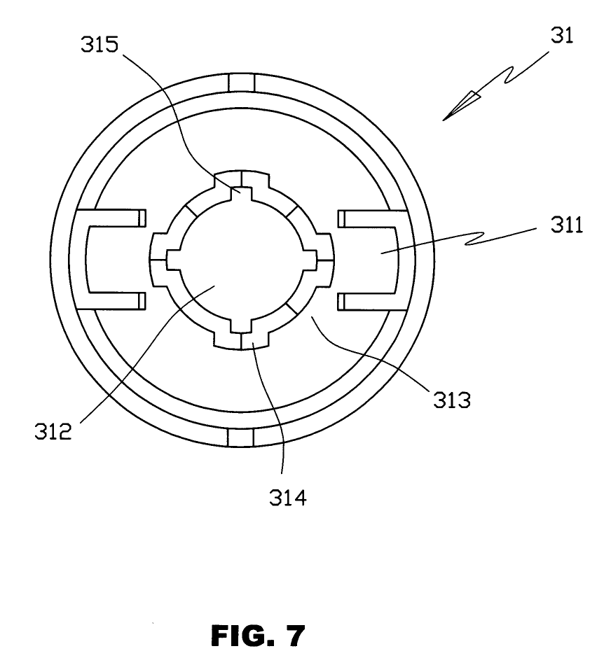

FIG. 5 through FIG. 7 show different views and members of the steering control assembly (3) of the invention. As shown in FIGS. 5, 6, and 7, the pivot shaft (23) being connected to the lower end of the foot tube (101) (see also FIG. 3) and shaft-connected to the wheel seat (2) makes the wheel seat (2) rotates relatively to the steering control assembly (3) in accordance with and using the pivot shaft (23) as a central axis of the shaft (see also FIG. 3). In the present embodiment, the steering control assembly (3) consists of a main body (31), a driving ring (32), a moving seat (33), a positioning pin (34), and a lower seat (35).

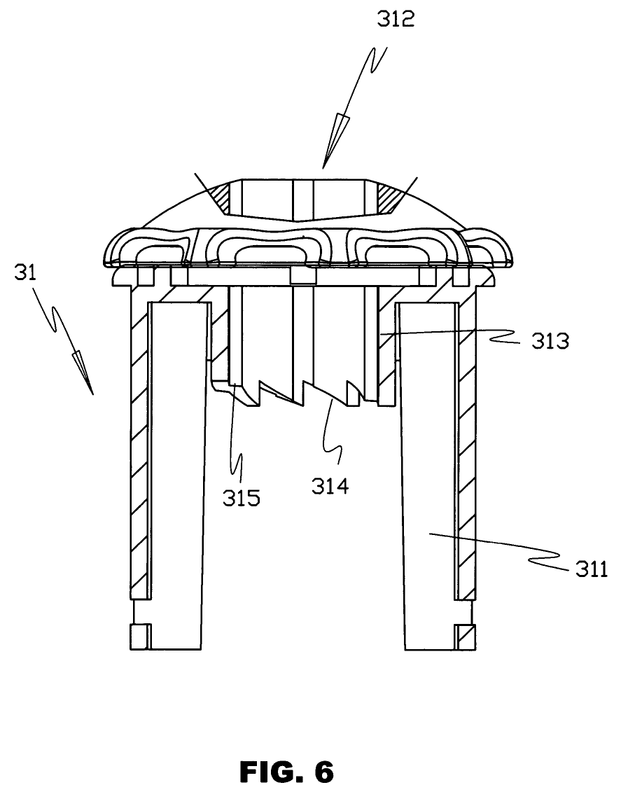

The main body (31) being inserted into the lower end of the foot tube (101) is fastened to the lower seat (35). A first guiding channel (311) being formed by extending the tvo sides of the main body (31) therefrom is capable of guiding the moving seat (33) to move. In the meantime, a positioning block (313) having a hollow cylinder (312) provided therein is formed by downward extending the main body (31). As shown in FIG. 6, a first ratchet portion (314) is formed at the lower end surface of the positioning block (313), and four second guiding channel (315) are provided on the interior surface of the hollow cylinder (312).

As shown in FIG. 5, a guiding block (331) being formed by extending from the moving seat (33) is guided by the first guiding channel (311) to make the moving seat (33), being constrained by the first guiding channel (311), linearly move up-and-down along the pivot shaft (23). A long cylinder (332) is further provided at the moving seat (33) for pivotally connecting to the positioning pin (34).

As shown again in FIG. 5, the positioning pin (34) being provided at the moving seat (33) is mounted opposite to the positioning spot (26). In the present embodiment, a buffer spring (36) is provided between the positioning pin (34) and the moving seat (33). Through the buffer spring (36), when the positioning pin (34) moves downward but does not align with the positioning spot (26), the positioning pin (34) is capable of pressing the buffer spring (36), moving within the long cylinder (332), and further waiting for the rotation of the positioning pin (34) to align with the positioning spot (26). Thereafter, by making use of the resilience of the buffer spring (36), the positioning pin (34) is pushed into the positioning spot (26) to maintain engaging status.

The driving ring (32) being slipped on the pivot shaft (23) and installed between the main body (31) and the moving seat (33) is employed to push the moving seat (33) moving downward. The driving ring (32) having a second ratchet portion (321) formed at its top end and having a pair of first guiding blocks (322) provided at the outer edge of two sides thereof is capable of moving up-and-down within the hollow cylinder (312) along the second guiding channel (315) in the positioning block (313) of the main body (31).

The pressing key (4) having a pair of second guiding blocks (41) extended from the two sides thereof is installed within the inner surface of the hollow cylinder (312) of the main body (31) in such a way that it is capable of linearly moving up-and-down. The upper portion of the pressing key (4) protruded above the main body (31) is for the operator to press and move within the hollow cylinder (312). Moreover, a third ratchet portion (42) is formed at the lower end of the pressing key (4) for engaging the second ratchet portion (321) of the driving ring (32).

A restoring spring (5) being installed between the moving seat (33) and lower seat (35) of the steering control assembly (3) is used for keeping the pushing force upward against the moving seat (33) and the driving ring (32) by the use of its resilience making the positioning spot (26) separate from the positioning spot (26) (see FIG. 4), and furthermore making the second ratchet portion (321) of the driving ring (32) keep engaging with the third ratchet portion (42) of the pressing key (4).

Under normal condition, by the use of the above-mentioned combination of the members, the positioning pin (34) constantly keeps separating from the positioning spot (26) of the wheel seat (2) (see FIG. 4) by making use of the resilience of the restoring spring (5) such that the wheel seat (2) is capable of freely steering with respect to pivot shaft (23).

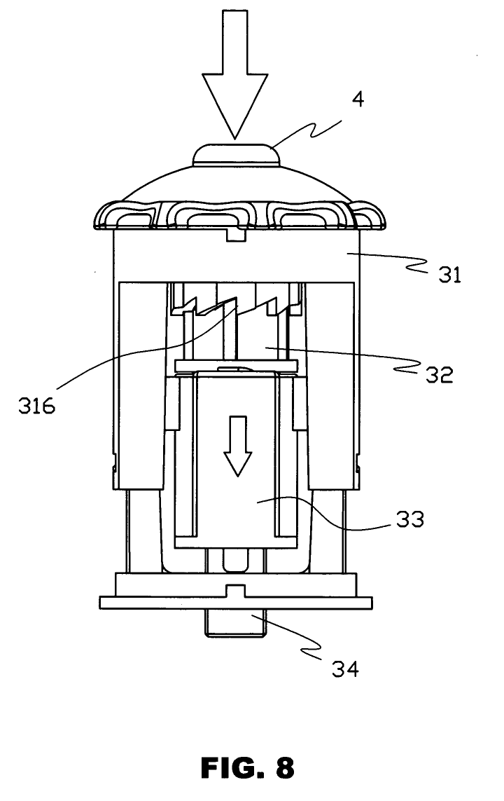

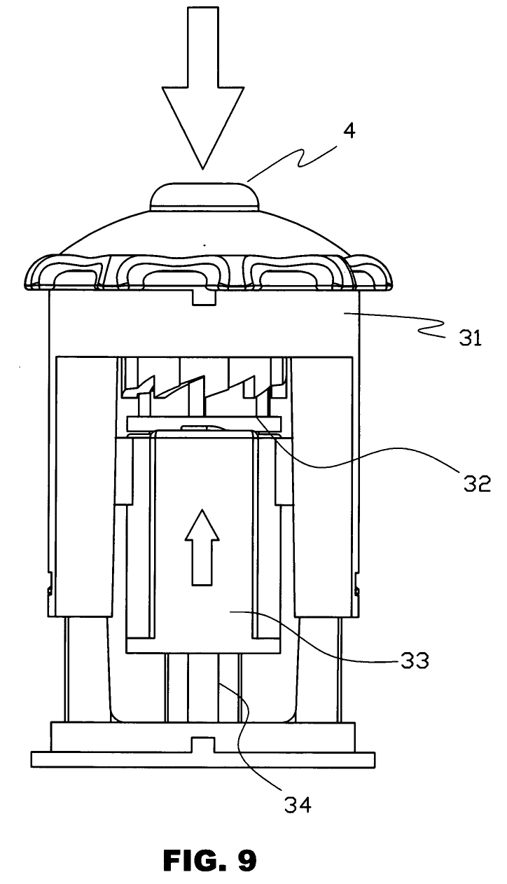

Referring to FIG. 8 and FIG. 9, when the operator desires to choose the wheel seat (2) to be in fixed direction without rotating, the pressing key (4) is pressed down for the first time to push down the driving ring (32), the moving seat (33), and the positioning pin (34) so as to make the positioning pin (34) enter the positioning spot (26). When the third ratchet portion (42) of the pressing key (4) pushes the driving ring (32) downward, the driving ring (32) being constrained by the second guiding channel (315) moves linearly downward. When the driving ring (32) moves downward and separate from the range of the second guiding channel (315) of the hollow cylinder (312), the second ratchet portion (321) of the driving ring (32) being persistently pushed by the third ratchet portion (42) begins to rotate along the slant surface of the third ratchet portion (42) of the pressing key (4). Accordingly, the first guiding blocks (322) formed at the outer edge of the driving ring (32) rotates and dislocate with the second guiding channel (315). At this moment, the first guiding blocks (322) being constrained by the first ratchet portion (314) at the end portion of the positioning block (313) of the main body (31) makes the first guiding blocks (322) position at a positioning portion (316) (the intersection of the ratchet's lowest and highest points) (see FIG. 8) so as to make the driving ring (32) unable to enter to the hollow cylinder (312). Consequently, the moving seat (33) and the positioning pin (34) move downward and make the positioning pin (34) keep engage with the positioning spot (26), thereby, the fact that the wheel seat (2) is unable to rotate again is capable of achieving the effect of fixed direction.

When the operator desires to make the wheel seat (2) steer freely in any direction, he/or she can press the pressing key (4) for the second time and then release it. The third ratchet portion (42) of the end surface of the pressing key (4) will further push the second ratchet portion (321) of the driving ring (32) that will make the driving ring (32) move downward and slightly rotate along the third ratchet portion (42) letting the first guiding blocks (322) of the driving ring (32) separate from the positioning portion (316). At this time, since the driving ring (32) is subjected to an upward resilient pushing force of the restoring spring (5), the first guiding blocks (322) of the driving ring (32) will move along the slant surface of the first ratchet portion (314) to make the first guiding blocks (322) enter the second guiding channel (315) of the hollow cylinder (312) of the main body (31). Moreover, since there is the restoring spring (5) provided below the moving seat (33) that is connected to the positioning pin (34), the moving seat (33) and the positioning pin (34) can move upward by making use of the resilience of the restoring spring (5) to separate from the positioning spot (26) of the wheel seat (2). Accordingly, the wheel seat (2) is capable of rotating freely with respect to the pivot shaft (23).

In accordance with the above-mentioned device, since the pressing key (4) is provided above the wheel (20) and the wheel seat (2), the operator is capable of touching it easily after he/or she selects either the fixed-direction steering or the non-fixed-direction steering. What is more, the operator, no matter whether he/or she selects the fixed-direction steering or the non-fixed-direction steering, needs only to press the pressing key (4) downward. In other words, the operator can directly step on the pressing key (4) by the sole bottom of his/or her shoe without having his/or her shoe vamp hook up anything, thereby, can achieve the effects of being convenient in operation and not damaging the operator's shoe vamp. It will become apparent to those people skilled in the art that various modifications and variations can be made to the mechanism of the invention without departing from the scope or spirit of the invention. In view of the foregoing description, it is intended that all the modifications and variation fall within the scope of the following appended claims and their equivalents.

1. A wheel steering mechanism for baby stroller mainly installed at the lower end of the baby stroller for controlling the status of fixed-direction steering or non-fixed-direction steering comprising:
a wheel seat for pivotally connecting to a wheel, and the wheel seat further includes a pivot shaft and a positioning spot;
a steering control assembly shaft connecting to the pivot shaft of the wheel seat and being connected to the lower end of a frame of the baby stroller, the steering control assembly further includes a positioning pin; and
a pressing key installed in the steering control assembly, when the pressing key is pressed down for the first time to make the positioning pin engage with the wheel seat, the wheel seat appears to be in the status of fixed-direction steering; but when the pressing key is pressed down for the second time to make the positioning pin separate from the wheel seat, the wheel assembly is capable of restoring back to the status of free steering.

2. The wheel steering mechanism for baby stroller as claimed in claim 1, wherein the positioning spot is a positioning hole.

3. The wheel steering mechanism for baby stroller as claimed in claim 1, wherein the pivot shaft of the wheel seat is perpendicularly extended upward and is pivotally connected to the steering control assembly.

4. The wheel steering mechanism for baby stroller as claimed in claim 1, wherein the wheel seat further includes a connecting seat, a pivotally connecting seat, and a shock-resistant spring; the connecting seat is pivotally connected to the pivotally connecting seat; and the shock-resistant spring being provided between the connecting seat and the pivotally connecting seat makes the connecting seat not only is capable of rotating but is capable of achieving the effect of shock-resistant.

5. The wheel steering mechanism for baby stroller as claimed in claim 1, wherein the steering control assembly being connected to the lower end of the foot tube of the frame of the baby stroller further includes a main body, a driving ring, a moving seat, and a lower seat, wherein the main body and the lower seat are fastened to the lower end of the foot tube while the driving ring and the moving seat are installed between the lower seat and the main body.

6. The wheel steering mechanism for baby stroller as claimed in claim 5, wherein a first guiding channel for the moving seat to move is formed by downward extending the two sides of the main body, and a first ratchet portion is formed at the lower end surface of the positioning block having a hollow cylinder, while a plurality of second guiding channels are provided on the inner surface of the hollow cylinder.

7. The wheel steering mechanism for baby stroller as claimed in claim 5, wherein a guiding block is formed by extending from the exterior side of the moving seat to make the moving seat be constrained by the first guiding channel of the main body and is capable of linearly moving up-and-down along the pivot shaft only.

8. The wheel steering mechanism for baby stroller as claimed in claim 7, wherein the moving seat further provides a long cylinder for pivotally connecting to the positioning pin.

9. The wheel steering mechanism for baby stroller as claimed in claim 8, wherein a buffer spring being provided between the moving seat and the positioning pin makes the positioning pin capable of moving in the range of the long cylinder.

10. The wheel steering mechanism for baby stroller as claimed in claim 5, wherein the driving ring being slipped on the pivot shaft of the wheel seat is provided between the main body and the moving seat; and a second ratchet portion is formed at the top end of the driving ring; and a pair of first guiding blocks being provided at the outer edge of the driving ring makes the driving ring that is guided by the first guiding blocks move up-and-down within the hollow cylinder of the positioning block along the second guiding channel in the positioning block of the main body.

11. The wheel steering mechanism for baby stroller as claimed in claim 1, wherein a pair of second guiding blocks formed by extending from the two sides of the pressing key that being guided by the second guiding blocks is installed in the second guiding channel of the hollow cylinder of the main body in such a way that the pressing key is capable of linearly moving up-and-down; and the pressing key having a third ratchet portion formed at the lower end thereof for engaging with the second ratchet portion of the driving ring protrudes out of the main body for the operator to press.

12. The wheel steering mechanism for baby stroller as claimed in claim 1, wherein a restoring spring being provided below the moving seat makes the positioning pin constantly keep separating from the positioning spot of the wheel seat under the normal condition so that the wheel seat is capable of rotating freely.

13. The wheel steering mechanism for baby stroller as claimed in claim 11, wherein the third ratchet portion provided at the lower end of the pressing key is capable of pushing the driving ring to move downward and separate from the range of the hollow cylinder of the main body, the driving ring begins to rotate along the third ratchet portion.

14. The wheel steering mechanism for baby stroller as claimed in claim 13, wherein when the pressing key is pressed down for the first time, the first guiding blocks of the driving ring separates from the second guiding channel of the hollow cylinder and rotates to locate at the positioning portion, at this moment, the driving ring and the moving seat are moving downward to make the positioning pin keep engaging with the wheel seat and make the wheel seat to be in the status of fixed-direction steering.

15. The wheel steering mechanism for baby stroller as claimed in claim 14, wherein the positioning portion is positioned at the intersection of the ratchet's lowest and highest points

16. The wheel steering mechanism for baby stroller as claimed in claim 11, wherein when the pressing key is pressed down for the second time, the third ratchet portion of the pressing key pushes the driving ring and makes the second ratchet portion of the driving ring rotate along the slant surface of the third ratchet portion and further makes the first guiding blocks of the driving ring enter the second guiding channel of the main body again, at this moment, the driving ring, the moving seat, and the positioning pin move upward by the use of the resilience of the restoring spring to make the positioning pin separate from the positioning spot of the wheel seat, accordingly, the wheel seat is capable of restoring back to the status of free rotations with respect to the pivot shaft.
